(19) United States
(12) Patent Application Publication
(10) Pub. No.: US 2023/0328785 A1
(43) Pub. Date: Oct. 12, 2023

(54) METHOD AND APPARATUS FOR CHANNEL ACCESS

(71) Applicant: LENOVO (BEIJING)LIMITED, Beijing (CN)

(72) Inventors: Yu ZHANG, Beijing (CN); Haipeng LEI, Beijing (CN)

(21) Appl. No.: 18/040,941

(22) PCT Filed: Aug. 7, 2020
(86) PCT No.: PCT/CN2020/107801

§ 371 Date: Feb. 7, 2023

(51) Int. Cl. H04W 74/08; H04B 7/06

(52) U.S. Cl. CPC H04W 74/0816; H04B 7/0695

(57) ABSTRACT

The present disclosure relates to a method and an apparatus for channel access. One embodiment of the present disclosure relates to a method performed by a User Equipment (UE), comprising: receiving control information for an uplink transmission associated with a first uplink transmission beam; determining a second uplink transmission beam associated with a Channel Occupancy (CO) initiated by a base station (BS) based on an indicator in first downlink control information (DCI), or based on a downlink reception beam for receiving the first DCI; and transmitting the uplink transmission using the second uplink transmission beam when the uplink transmission is within a duration in time domain and location in frequency domain of the CO initiated by the BS.

### TECHNICAL FIELD

The present disclosure generally relates to wireless communication technology, and especially to a method and apparatus for channel access, e.g., for 5G new radio on unlicensed spectrum (NR-U) uplink or downlink transmission.

### BACKGROUND OF THE INVENTION

A base station (BS) and a user equipment (UE) may operate in both licensed and unlicensed spectrum. Listen before talk (LBT) is a channel access technique used for transmission on unlicensed spectrum. For transmission on unlicensed spectrum, in order to achieve fair coexistence with other wireless systems, LBT procedures are required to be performed before a transmitter (e.g., a BS or a UE) can start a transmission on unlicensed spectrum.

LBT is executed based on performing energy detection on a certain channel. Only when LBT procedures generate a success result, the transmitter can start the transmission on the channel and occupy the channel up to a maximum channel occupancy time (MCOT); otherwise, the transmitter cannot start the transmission and continue performing LBT procedures until the LBT procedures generate a success result. There are multiple categories of LBT procedures, for example LBT Cat1, LBT Cat2, LBT Cat3 and LBT Cat4. LBT Cat2 means that LBT procedures are performed without random back-off, and the duration of time that the channel is sensed to be idle before the transmitter transmits is deterministic. LBT Cat4 means that LBT procedures are performed with random back-off with a variable contention window size. Generally, LBT Cat4 is more complex than LBT Cat2, and requires more overhead.

For further improve the probability of successful channel access and enhance the spatial reuse, directional LBT is introduced, which is LBT with energy detection via narrow beam. Therefore, it is necessary for the UE and the BS to know the directional LBT related information for channel access.

### SUMMARY

One embodiment of the subject application provides a method performed by a User Equipment (UE), which includes: receiving control information for an uplink transmission associated with a first uplink transmission beam; determining a second uplink transmission beam associated with a Channel Occupancy (CO) initiated by a base station (BS) based on an indicator in first downlink control information (DCI), or based on a downlink reception beam for receiving the first DCI; and transmitting the uplink transmission using the second uplink transmission beam when the uplink transmission is within a duration in time domain and location in frequency domain of the CO initiated by the BS.

Another embodiment of the subject application provides a method performed by a Base Station (BS), comprising: transmitting control information for an uplink transmission associated with a first uplink transmission beam to a user equipment (UE); indicating a second uplink transmission beam associated with a Channel Occupancy (CO) initiated by the BS with an indicator in downlink control information (DCI); and receiving the uplink transmission using an uplink reception beam corresponding to the second uplink transmission beam when the uplink transmission is within a duration in time domain and location in frequency domain of the CO initiated by the BS.

Yet another embodiment of the subject application provides a method performed by a Base Station (BS), comprising: transmitting control information for an uplink transmission associated with a first uplink transmission beam to a user equipment (UE); transmitting downlink control information (DCI) with a second downlink transmission beam; and receiving the uplink transmission using an uplink reception beam corresponding to the second downlink transmission beam when the uplink transmission is within a duration in time domain and location in frequency domain of a Channel Occupancy (CO) initiated by the BS.

Still another embodiment of the subject application provides a method performed by a User Equipment (UE), comprising: receiving control information for a downlink transmission associated with a first downlink transmission beam; indicating a second downlink transmission beam associated with a Channel Occupancy (CO) initiated by the UE with an indicator in configured grant uplink control information (CG-UCI); and receiving the downlink transmission using a downlink reception beam corresponding to the second downlink transmission beam when the downlink transmission is within a duration in time domain and location in frequency domain of the CO initiated by the UE.

Still another embodiment of the subject application provides a method performed by a User Equipment (UE), comprising: receiving control information for a downlink transmission associated with a first downlink transmission beam; transmitting an uplink transmission with a second uplink transmission beam; and receiving the downlink transmission using a downlink reception beam corresponding to the second uplink transmission beam when the downlink transmission is within a duration in time domain and location in frequency domain of a Channel Occupancy (CO) initiated by the UE.

Still another embodiment of the subject application provides a method performed by a Base Station (BS), comprising: transmitting control information for a downlink transmission associated with a first downlink transmission beam to a User Equipment (UE); determining a second downlink transmission beam associated with a Channel Occupancy (CO) initiated by the UE based on an indicator in configured grant uplink control information (CG-UCI), or based on an uplink reception beam for receiving an uplink transmission; and transmitting the downlink transmission using the second downlink transmission beam when the downlink transmission is within a duration in time domain and location in frequency domain of the CO initiated by the UE.

Still another embodiment of the subject application provides an apparatus, comprising: a non-transitory computer-readable medium having stored thereon computer-executable instructions; a receiving circuitry; a transmitting circuitry; and a processor coupled to the non-transitory computer-readable medium, the receiving circuitry and the transmitting circuitry, wherein the computer-executable instructions cause the processor to implement the method performed by a User Equipment (UE), which includes: receiving control information for an uplink transmission associated with a first uplink transmission beam; determining a second uplink transmission beam associated with a Channel Occupancy (CO) initiated by a base station (BS) based on an indicator in downlink control information (DCI), or based on a downlink reception beam for receiving the DCI; and transmitting the uplink transmission using the second uplink transmission beam when the uplink transmission is within a duration in time domain and location in frequency domain of the CO initiated by the BS.

### BRIEF DESCRIPTION OF THE DRAWINGS

FIG. 1 illustrates a schematic diagram of a wireless communication system according to some embodiments of the present disclosure.

FIG. 2a illustrates an over protection scenario due to the Omni-directional LBT.

FIG. 2b illustrates a solution for the over protection scenario due to the Omni-directional LBT as illustrated in FIG. 2a.

FIG. 3a illustrates one solution for determining an uplink transmission/reception beam according to some embodiments of the present disclosure.

FIG. 3b illustrates another solution for determining an uplink transmission/reception beam according to some embodiments of the present disclosure.

FIG. 4a illustrates another solution for determining a downlink transmission/reception beam according to some embodiments of the present disclosure.

FIG. 4b illustrates another solution for determining a downlink transmission/reception beam according to some embodiments of the present disclosure.

FIG. 5 illustrates a method performed by a UE for wireless communication according to some embodiments of the present disclosure.

FIG. 6 illustrates a method performed by a BS for wireless communication according to some embodiments of the present disclosure.

FIG. 7 illustrates a method performed by a BS for wireless communication according to some embodiments of the present disclosure.

FIG. 8 illustrates a method performed by a UE for wireless communication according to some embodiments of the present disclosure.

FIG. 9 illustrates a method performed by a UE for wireless communication according to some embodiments of the present disclosure.

FIG. 10 illustrates a method performed by a BS for wireless communication according to some embodiments of the present disclosure.

FIG. 11 illustrates a block diagram of a UE according to the embodiments of the present disclosure.

FIG. 12 illustrates a block diagram of a BS according to the embodiments of the present disclosure.

### DETAILED DESCRIPTION

The detailed description of the appended drawings is intended as a description of the currently preferred embodiments of the present invention, and is not intended to represent the only form in which the present invention may be practiced. It should be understood that the same or equivalent functions may be accomplished by different embodiments that are intended to be encompassed within the spirit and scope of the present invention.

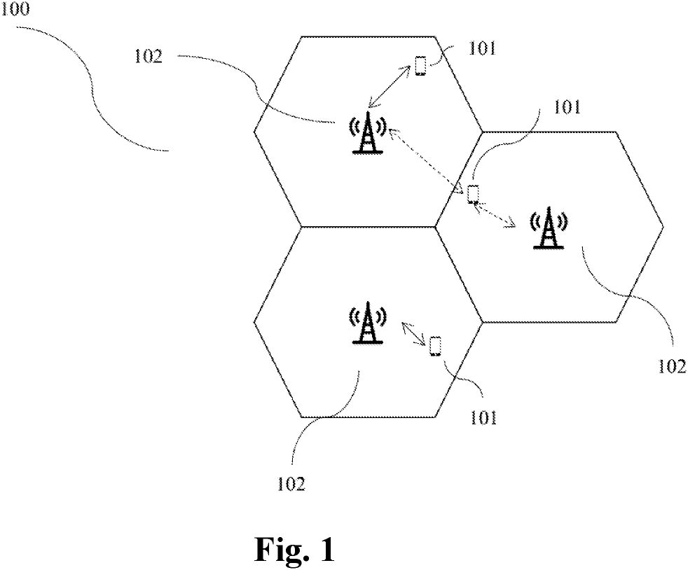

FIG. 1 illustrates a wireless communication system 100 according to an embodiment of the present disclosure.

As shown in FIG. 1, the wireless communication system 100 includes UEs 101 and BSs 102. In particular, the wireless communication system 100 includes three UEs 101 and three BSs 102 for illustrative purpose only. Even though a specific number of UEs 101 and BSs 102 are depicted in FIG. 1, one skilled in the art will recognize that any number of UEs 101 and BSs 102 may be included in the wireless communication system 100.

The UEs 101 may include computing devices, such as desktop computers, laptop computers, personal digital assistants (PDAs), tablet computers, smart televisions (e.g., televisions connected to the Internet), set-top boxes, game consoles, security systems (including security cameras), vehicle on-board computers, network devices (e.g., routers, switches, and modems), or the like. According to an embodiment of the present disclosure, the UEs 101 may include a portable wireless communication device, a smart phone, a cellular telephone, a flip phone, a device having a subscriber identity module, a personal computer, a selective call receiver, or any other device that is capable of sending and receiving communication signals on a wireless network. In some embodiments, the UEs 101 include wearable devices, such as smart watches, fitness bands, optical head-mounted displays, or the like. Moreover, each of the UEs 101 may be referred to as a subscriber unit, a mobile phone, a mobile station, a user, a terminal, a mobile terminal, a wireless terminal, a fixed terminal, a subscriber station, a user terminal, or any device described using other terminology used in the art. The UEs 101 may communicate directly with the BSs 102 via uplink (UL) communication signals.

The BSs 102 may be distributed over a geographic region. In certain embodiments, each of the BSs 102 may also be referred to as an access point, an access terminal, a base, a macro cell, a Node-B, an enhanced Node B (eNB), a gNB, a Home Node-B, a relay node, or any device described using other terminology used in the art. The BSs 102 are generally part of a radio access network that may include one or more controllers communicably coupled to one or more corresponding BSs 102.

The wireless communication system 100 is compatible with any type of network that is capable of sending and receiving wireless communication signals. For example, the wireless communication system 100 is compatible with a wireless communication network, a cellular telephone network, a Time Division Multiple Access (TDMA)-based network, a Code Division Multiple Access (CDMA)-based network, an Orthogonal Frequency Division Multiple Access (OFDMA)-based network, an LTE network, a 3rd Generation Partnership Project (3GPP)-based network, a 3GPP 5G network, a satellite communications network, a high altitude platform network, and/or other communications networks.

In one embodiment, the wireless communication system 100 is compatible with the 5G NR of the 3GPP protocol, wherein the BSs 102 transmit data using an orthogonal frequency division multiplexing (OFDM) modulation scheme on the downlink and the UEs 101 transmit data on the uplink using Discrete Fourier Transform-Spread-Orthogonal Frequency Division Multiplexing (DFT-S-OFDM) or Cyclic Prefix-Orthogonal Frequency Division Multiplexing (CP-OFDM) scheme. More generally, however, the wireless communication system 100 may implement some other open or proprietary communication protocols, for example, WiMAX, among other protocols.

In other embodiments, the BSs 102 may communicate using other communication protocols, such as the IEEE 802.11 family of wireless communication protocols. Further, in some embodiments, the BSs 102 may communicate over licensed spectrums, whereas in other embodiments the BSs 102 may communicate over unlicensed spectrums. The present disclosure is not intended to be limited to the implementation of any particular wireless communication system architecture or protocol. In another embodiment, the BSs 102 may communicate with the UEs 101 using 3GPP 5G protocols.

In order to achieve high link gain and wide coverage, beamforming is used for the transmission on the millimeter wave (mmWave) band, for example, the frequency band around 60 GHz. The Omni-directional LBT used in License Assisted Access (LAA), Enhanced License Assisted Access (eLAA), Further Enhanced License Assisted Access (FeLAA), or NR-Unlicensed (NR-U) Frequency Range 1 (FR1, 450 MHz - 6000 MHz), may cause some issues. For example, the biggest one is over protection.

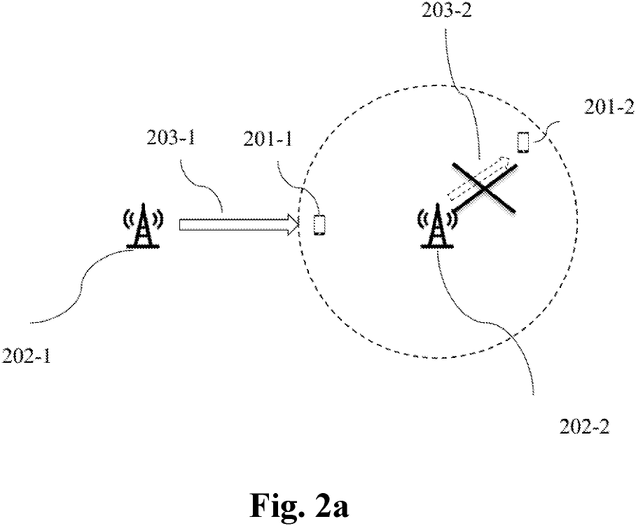

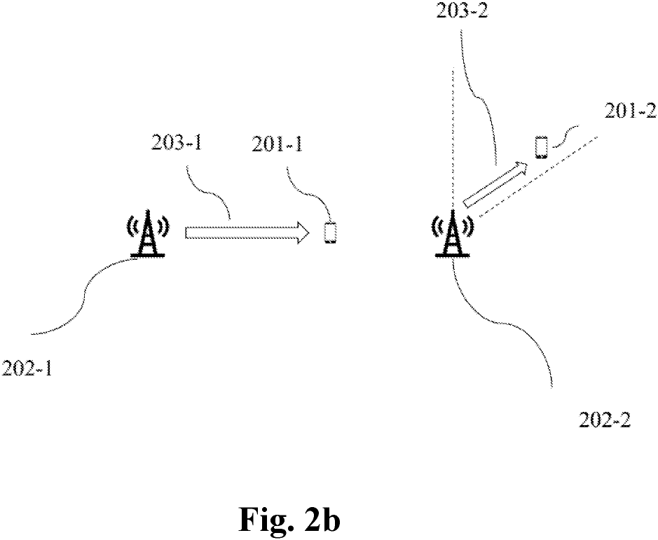

FIG. 2a illustrates an over protection scenario in NR-U due to the Omni-directional LBT. In FIG. 2a, the BS 202-1 is transmitting a data to the UE 201-1 using the transmission beam 203-1. Meanwhile, the BS 202-2 also intends to transmit a data to the UE 201-2, therefore, the BS 202-2 needs to perform the LBT procedures. The BS 202-2 performs the Omni-directional LBT procedures, and senses the strong signal from the BS 202-1 to the UE 201-1. Therefore, the BS 202-2 determines the Omni-directional LBT procedures generate a failure result, and would not transmit the data to the UE 201-2, until the Omni-directional LBT procedures generate a success result.

In other words, the strong signal sensed from the beam direction, namely, the direction from the BS 202-1 to the UE 201-1, could block the transmissions of other nodes in other beam directions, for example, the beam direction from the BS 202-2 to the UE 201-2 in FIG. 2a, even if they can communicate at the same time without interfering each other. Accordingly, the Omni-directional LBT decreases the spatial multiplexing efficiency.

FIG. 2b illustrates a solution for the over protection scenario due to the Omni-directional LBT as illustrated in FIG. 2a. This solution involves the directional LBT, which is LBT with energy detection via narrow beam. In FIG. 2b, the BS 202-1 is transmitting data to the UE 201-1 using the beamforming technique. Meanwhile, the BS 202-2 intends to communicate with the UE 201-2, therefore, the BS 202-2 needs to perform the LBT procedures. Instead of Omni-directional LBT procedures, the BS 202-2 performs the directional LBT procedures in the region marked with dashed lines, and the directional LBT procedures generate a success result. Therefore, the BS 202-2 would transmit data to the UE 201-2 for a channel occupancy time (COT). Clearly, the method in FIG. 2b improves the spatial multiplexing efficiency.

However, with the beamforming technique, other issues may occur, thus further modifications are needed in current NR specification when implementing directional LBT mechanism.

The first issue relates to sharing a channel occupancy (CO) initiated by a BS with a UE. At present, when the UE’s uplink transmission, which includes Physical Uplink Control Channel (PUCCH) and Physical Random Access Channel (PRACH) transmissions, is within the determined duration in time domain and location in frequency domain of the remaining CO initiated by the BS, the UE may switch from LBT Cat4 to LBT Cat2 to access the channel, so as to reduce the overhead caused by channel access procedures. However, under directional LBT scenario, the UE should also guarantee that the uplink (UL) transmission (Tx) beam(s) used for the corresponding UL transmission(s) is restricted within the spatial region of the CO. However, in some cases, the UE lacks the information about whether the earlier-indicated UL transmission beam(s) is within the spatial region of the CO initiated by the BS, therefore, the transmission from UE may not be received.

The second issue exists when the BS shares the CO initiated by a UE. LBT Cat2 procedures are applicable to the transmission(s) by a BS following transmission(s) by a UE in a shared CO. But under directional LBT scenario, the BS should also guarantee that the downlink (DL) transmission (Tx) beam(s) of the transmission(s) is restricted within the spatial region of the CO initiated by the UE. In some cases, the BS will select another DL transmission beam to meet the criterion of sharing the CO but the UE lacks the related information thus may not receive the corresponding DL transmission correctly, for example, the UE may not know which DL reception (Rx) beam to use.

In this disclosure, we propose several solutions to solve the above issues.

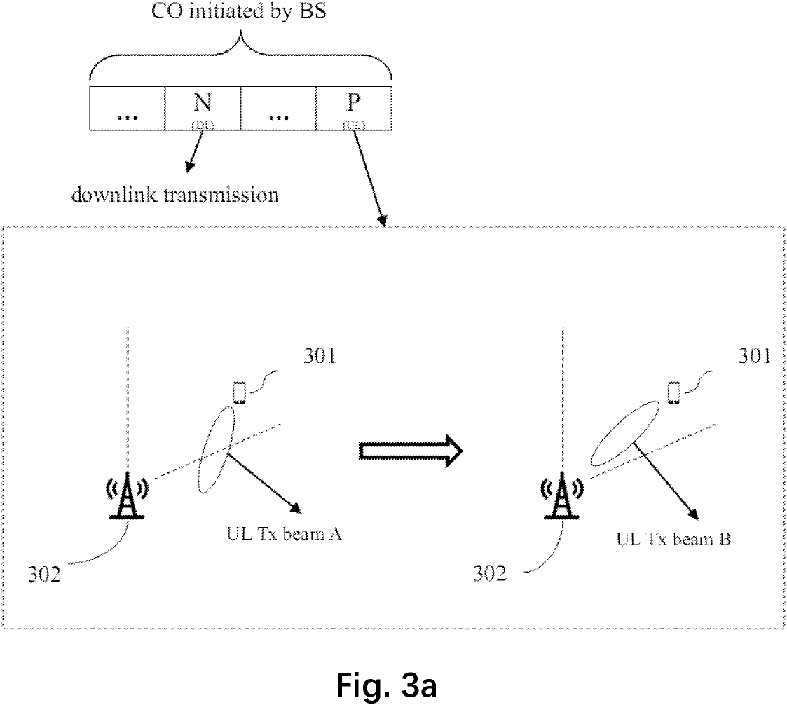

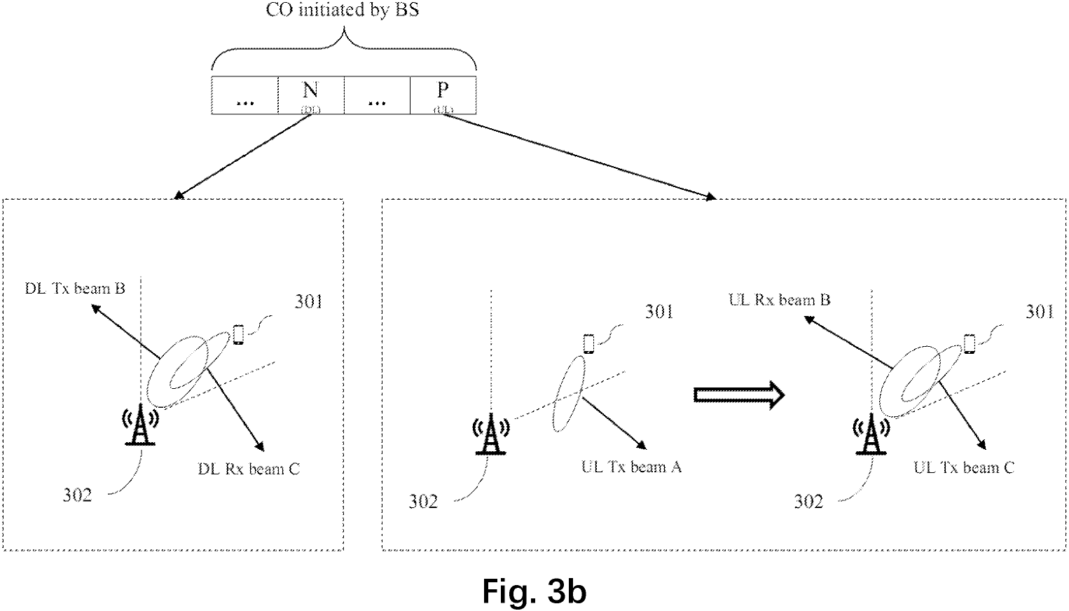

Regarding the first issue, FIGS. 3a and 3b proposes several solutions for determining uplink transmission/reception beams to ensure the communication.

FIG. 3a illustrates one solution for determining an uplink transmission/reception beam according to some embodiments of the present disclosure. In FIG. 3a, the BS 302 performs directional LBT procedures to initiate the CO, which is corresponding to the region marked with dashed lines, and the CO occupies several slots, for example, slot N for downlink transmission and slot P is shared to the UE 301 for uplink transmission.

Before slot P, the UE 301 determines that the duration in time domain and the location in frequency domain of a remaining CO initiated by the BS 302. The UE 301 also determines that its PRACH or PUCCH transmissions are within the determined duration in time domain and location in frequency domain of the remaining CO.

Regarding the uplink transmission beam for the PRACH or PUCCH transmission, an uplink transmission beam is indicated to the UE 301 for the PUCCH or PRACH transmission by preciously received downlink control information (DCI) and/or higher layer signaling, for example, the uplink transmission beam A may be indicated by preciously received DCI and/or the higher layer signaling before slot N. As can be seen in FIG. 3a, the previously indicated uplink transmission beam A is not within the region marked with dashed lines. In other words, the uplink transmission beam A does not meet the criterion for the UE switching from LBT Cat4 to LBT Cat2.

In FIG. 3a, in slot N, the BS 302 transmits new DCI, for example, DCI format 2_0, which includes a field for indicating uplink transmission beam B to the UE 301, and uplink transmission beam B is within the region marked with dashed lines, thus it satisfies the criterion for the UE 301 switching from LBT Cat4 to LBT Cat2. The field may be named as “directional CO sharing information”, which is used to indicate the directional CO sharing information. It should be noted that the field may be represented with other names, and the present disclosure has no intention of limiting the same.

After receiving the new DCI with the field “directional CO sharing information” in slot N, the UE 301 knows that it should use uplink transmission beam B for the PUCCH or PRACH transmission after performing LBT Cat2.

In slot P, after performing LBT Cat2, the UE 301 performs the PUCCH or PRACH transmissions using the uplink transmission beam B. Correspondingly, the BS 302 receives the PUCCH or PRACH transmissions using uplink reception beam corresponding to the uplink transmission beam B.

In one embodiment, the information included in the field “directional CO sharing information” in the new DCI may include the following information: i) the UE cannot share the CO initiated by the BS, and ii) Sounding Reference Signal (SRS) resource(s) information configured by higher layer signaling.

Assuming there are M states in the field, wherein M is an integer larger than 1, then these states may have the following detailed indications:
i. the first state of the field indicates that the UE cannot share the remaining CO initiated by the BS;
ii. the second state of the field indicates that the UE can share the remaining CO initiated by the BS by using the UL transmission beam corresponding to the first SRS resource;
iii. the M^{th} state of the field indicates that the UE can share the remaining CO initiated by the BS by using the UL transmission beam corresponding to the (M-1)^{th} SRS resource.

For example, suppose that there are three SRS resources (SRS resource 0, 1 and 2) configured to the UE by higher layer signaling, so combined with state that “the UE cannot share the remaining CO initiated by the BS”, there are four states in total. Therefore, two bits are required in this field, and the BS may jointly encode the following information as follows:
i. The value of the field is “00”, indicating that the UE cannot share the CO initiated by the BS;
ii. The value of the field is “01”, indicating that the UE can share the CO by using the UL transmission beam A corresponding to the SRS resource 0;
iii. The value of the field is “10”, indicating that the UE can share the CO by using the UL transmission beam B corresponding to the SRS resource 1; and
iv. The value of the field is “11”, indicating that the UE can share the CO by using the UL transmission beam C corresponding to the SRS resource 2.

It should be understood that determining the uplink transmission beam by the UE according to the correspondence to SRS resource is just an example, and persons skilled in the art would appreciate that other methods for determining the uplink transmission beam can also be used according to actual situations or needs. In the present disclosure, the BS 302 decides whether the UE 301 can share the CO and the UL beam to be used by the UE 301, and there is a criterion for the BS 302 deciding whether the LBT Cat4 to LBT Cat2 switching is allowed.

FIG. 3b illustrates another solution for determining an uplink transmission/reception beam according to some embodiments of the present disclosure. In this solution, the UE 301 determines that at least one of its PRACH or PUCCH transmission is within the duration in time domain and the location in frequency domain of a remaining CO initiated by the BS 302, meanwhile the BS 302 also does not indicate the uplink transmission beam for the UE 301 by an indicator in the new DCI in slot N. Under this condition, the UE 301 determines the uplink transmission beam based on the downlink receiving beam for receiving the new DCI from the BS 302, and then transmits at least one of its PRACH or PUCCH transmission with the determined uplink transmission beam. In addition to the new DCI, the UE may determine the uplink transmission beam based on the downlink receiving beam for receiving other signals from the BS 302, for example, the PDCCH, PDSCH, the latest received signal, or the like.

In FIG. 3b, the UE 301 is configured or scheduled with at least one PUCCH or PRACH resource in slot P, and a UL transmission Beam A is indicated for the corresponding PUCCH or PRACH transmission by preciously received DCI and/or the higher layer signaling before slot N.

Before slot P, the BS 302 performs directional LBT procedures to initiate the CO, which is corresponding to the region marked with dashed lines, and the PUCCH or PRACH resource in slot P is within the duration in time domain and location in frequency domain of the CO. However, as can be seen in FIG. 3b, the previously indicated UL transmission beam A is not within the region marked with dashed lines, thus it does meet the criterion for the UE 301 switching from LBT Cat4 to LBT Cat2. In slot N, the BS 302 indicates the duration in time domain and the location in frequency domain of the remaining CO to the UE 301 by new DCI, which is transmitted by using the DL transmission Beam B.

In slot N, the UE 301 receives the new DCI using a DL reception Beam C corresponding to the DL transmission Beam B, then knows that the PUCCH or PRACH resource in slot P is within the duration in time domain and location in frequency domain of the CO and it should use UL transmission beam C corresponding to the DL reception Beam C for the PUCCH or PRACH transmission(s) after performing LBT Cat2.

In slot P, the UE 301 performs LBT Cat2 then transmits the PUCCH or PRACH using the UL transmission beam C, and the BS 302 receives the PUCCH or PRACH transmission using a UL reception beam B corresponding to the DL transmission Beam B.

It should be noted that the UL reception beam B used by the BS 302 and the UL transmission beam C used by the UE 301 correspond to each other, and the UL reception beam B used by the BS 302 and the DL transmission beam B used by BS 302 also correspond to each other, that is, the UL reception beam B used by the BS 302 has two corresponding beams, one is the UL transmission beam C used by UE 301, and the other is the DL transmission beam B used by BS 302 per se.

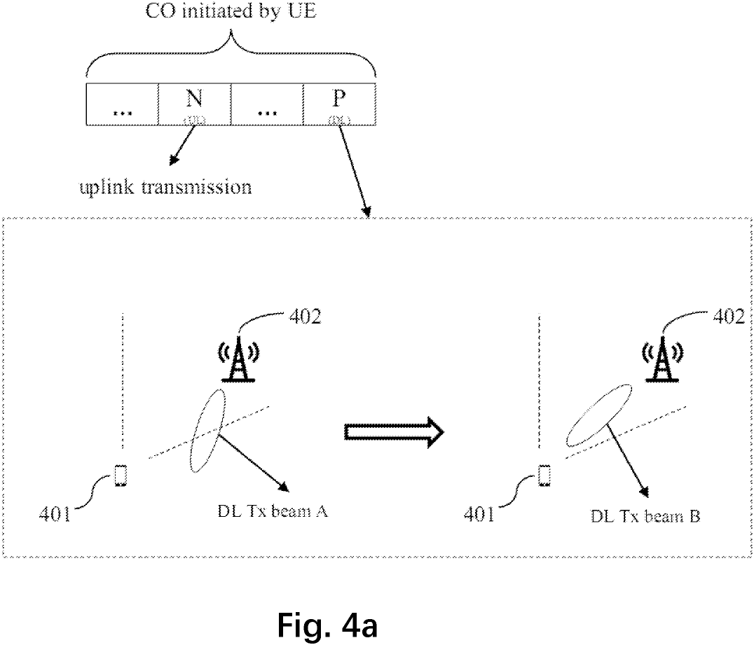

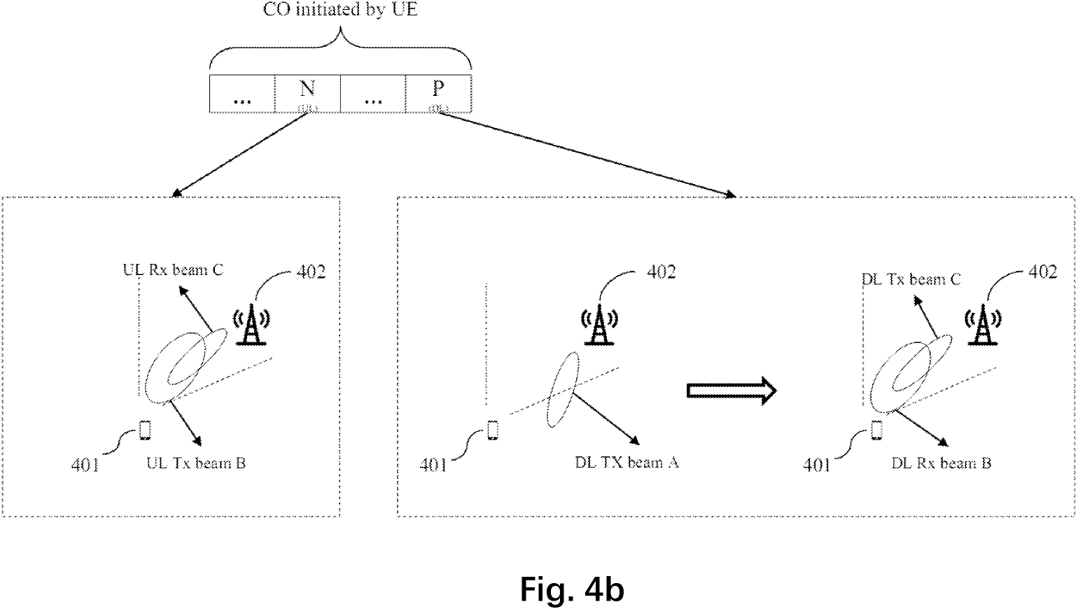

Regarding the second issue, FIGS. 4a and 4b propose several solutions for determining uplink or downlink transmission/reception beams to ensure the communication.

FIG. 4a illustrates another solution for determining a downlink transmission/reception beam according to some embodiments of the present disclosure.

In FIG. 4a, the UE 401 performs directional LBT procedures to initiate the CO, which is corresponding to the region marked with dashed lines, and the CO occupies several slots, for example, slot N for uplink transmission, and slot P which is shared to the BS 402 for downlink transmission.

The BS 402 may schedule or configure a PDCCH or PDSCH transmission to a UE 401 in slot P, and a DL transmission beam A for the PDCCH or PDSCH transmission is also indicated to the UE 401 by DCI or higher layer signaling.

In slot N, the BS 402 receives an uplink transmission carrying CG-UCI from the UE 401, and is aware that the PDCCH or PDSCH transmission in slot P is within the duration in time domain and location in frequency domain of the CO initiated by the UE 401 by decoding the CG-UCI. As can be seen in FIG. 4a, the previously indicated downlink transmission beam A, is not within the region marked with dashed lines. In other words, the uplink transmission beam A does not meet the criterion for the BS 402 sharing the CO initiated by the UE 401.

The present disclosure proposes to introduce a new field in the CG-UCI, to indicate a new DL transmission Beam B for the PDCCH or PDSCH transmission from the BS 402.

After receiving the CG-UCI with the new field, in slot P, the BS 402 transmits the PDCCH or PDSCH using the DL transmission beam B instead of DL transmission beam A after performing LBT Cat2, and the UE 401 receives the PDCCH or PDSCH transmission using the DL reception beam corresponding to the DL transmission Beam B.

In the first embodiment of the solutions of FIG. 4a, the present disclosure proposes to introduce a field in the CG-UCI indicating “TCI state for sharing CO”.

The BS 402 may determine a new DL transmission beam for its transmission(s) within the duration in time domain and the location in frequency domain of a remaining CO initiated by a UE, according to the “TCI state for sharing CO” field received in the CG-UCI. In this embodiment, this field do not include a state for indicating that the BS is not allowed to share the CO, and the present disclosure relies on a known method in the 3GPP documents to indicate whether the BS is allowed to share the CO or not.

Suppose there are M TCI states, wherein M is an integer larger than 1, and the UE 401 may encode the TCI state information as follows:
i. the first state of the field indicates that the BS should use the first DL transmission beam corresponding to a first TCI state if the BS can share the CO.
ii. the second state of the field indicates that the BS should use the second DL transmission beam corresponding to a second TCI state if the BS can share the CO;
iii. the M^{th} state of the field indicates that the BS should use the M^{th} DL transmission beam corresponding to the M^{th} TCI state if the BS can share the CO.

In the second embodiment of the solutions of FIG. 4a, a new field is introduced in the CG-UCI, to indicate the directional CO sharing information, which includes whether the BS is allowed to share the CO, and also includes the specific downlink transmission beam for the BS. Based on this field, for example, “directional CO sharing information”, in the CG-UCI, the BS may determine whether the BS can share the CO and a new DL transmission beam for its transmission(s) within the duration in time domain and the location in frequency domain of a remaining CO initiated by a UE. It should be noted that the name “directional CO sharing information,” for this field is just a general description, and the present disclosure has no intention of limiting the name of this function.

The UE 401 encodes both the information “the BS cannot share the CO” and TCI state information into this field, for example, suppose there are M TCI states, then the states might indicate:
i. the first state of the field indicates that the BS cannot share the remaining CO initiated by the UE;
ii. the second state of the field indicates that the BS can share the remaining CO initiated by the UE by using the DL transmission beam corresponding to the first TCI state;
iii. the (M+1)^{th} state of the field indicates that the BS can share the remaining CO initiated by the UE by using the DL transmission beam corresponding to the M^{th} TCI state.

Assume that there are three TCI states (TCI state 0, 1 and 2) are configured to the UE 401 by higher layer signaling, so combined with state that “the UE cannot share the remaining CO initiated by the BS,” there are four states in total. Therefore, two bits are required in this field, thus for this field in the CG-UCI, the UE 401 may jointly encode the information as follows:
i. The value of the field is “00,” indicating that the BS cannot share the CO initiated by the UE;
ii. The value of the field is “01,” indicating that the BS can share the CO by using the UL transmission beam A corresponding to TCI state 0.
iii. The value of the field is “10,” indicating that the BS can share the CO by using the UL transmission beam B corresponding to TCI state 1.
iv. The value of the field is “11,” indicating that the BS can share the CO by using the UL transmission beam C corresponding to TCI state2.

In the third embodiment of the solutions of FIG. 4a, a table in the higher layer signaling is introduced for the BS sharing a CO initiated by a UE. In this table, each row provides “higher layer CO sharing information”. One row of the table is configured for indicating that the “higher layer CO sharing information” is not available.

The “CO sharing information” field in the CG-UCI indicates a row index of the table. The BS may determines whether it can share the CO and a new DL transmission beam for its transmission(s) within the duration in time domain and the location in frequency domain of a remaining CO initiated by the UE, according to the “CO sharing information” field received in the CG-UCI and the indicated “higher layer CO sharing information” in the table.

Assuming that there are M rows in the table, wherein M is an integer larger than 1, then the table may be presented as follows:
i. The first row indicates that the “higher layer CO sharing information” is not available;
ii. The second row indicates the first “higher layer CO sharing information” which at least indicates the BS can share the remaining CO by using the first DL transmission beam corresponding to a first TCI state.
iii. The third row indicates the second “higher layer CO sharing information” which at least indicates the BS can share the remaining CO by using the second DL transmission beam corresponding to a second TCI state.
iv. The M^{th} row indicates the (M-1)^{th} “higher layer CO sharing information” which at least indicates the BS can share the remaining CO by using the (M-1)^{th} DL transmission beam corresponding to a (M-1)^{th} TCI state.

One example of the table with four rows, which requires two bits to indicate the row index, may be shown in Table 1 below:

TABLE 1

| row index | higher layer CO sharing information |
|---|---|
| 00 | the “higher layer CO sharing information” is not available. |
| 01 | the first “higher layer CO sharing information” which at least indicates the BS can share the remaining CO by using the first DL transmission beam corresponding to the first TCI state. |
| 10 | the second “higher layer CO sharing information” which at least indicates the BS can share the remaining CO by using the second DL transmission beam corresponding to the second TCI state. |
| 11 | the third “higher layer CO sharing information” which at least indicates the BS can share the remaining CO by using the third DL transmission beam corresponding to the third TCI state. |

In slot N, the BS 402 receives a CG-UCI including the “CO sharing information” field, and knows that the PDCCH or PDSCH transmission in slot P is within the duration in time domain and location in frequency domain of the CO initialized by the UE 401, and the BS 402 can share the CO using a new DL transmission Beam B for the PDCCH or PDSCH transmission. In slot P, the BS 402 transmits the PDCCH or PDSCH using the DL transmission beam B after performing LBT Cat2, and the UE 401 receives the PDCCH or PDSCH using the DL reception beam corresponding to the DL transmission Beam B.

In conclusion, in this embodiment, the BS receives the indicator “CO sharing information” in the CG-UCI, which indicates a row index of the table to determine higher layer CO sharing information, and based on the higher layer CO sharing information in the indicated row, the BS performs downlink PDCCH or PDSCH transmission.

FIG. 4b illustrates another solution for determining a downlink transmission/reception beam according to some embodiments of the present disclosure.

In this embodiment, the UE does not indicate the downlink transmission beam explicitly. Under this circumstance, when the BS determines that a PDCCH or PDSCH transmission is within the duration in time domain and the location in frequency domain of a remaining CO initiated by the UE, the BS will transmit the PDCCH or PDSCH transmission by using the DL transmission Beam corresponding to the UL reception Beam for an uplink data transmission, the uplink data transmission may be PUSCH, PUCCH, SRS, or the like. This embodiment uses PUSCH as an example to present the solution, it should be noted that the PUCCH, SRS, the latest uplink transmission, or the like, also applies in this embodiment.

For example, in FIG. 4b, the UE 401 performs directional LBT procedures to initiate the CO, which is corresponding to the region marked with dashed lines, and the CO occupies several slots, for example, slot N for uplink transmission, and slot P is shared to the BS for downlink transmission. The BS 402 schedules or configures a PDCCH or PDSCH transmission to the UE 401 in slot P, and a DL transmission beam A for the PDCCH or PDSCH transmission is also indicated by DCI or higher layer signaling.

In slot N, the UE 401 transmits the PUSCH transmission using the UL transmission Beam B, and the BS 402 receives the PUSCH transmission using the UL reception Beam C, which corresponds to the UL transmission Beam B. Before slot P, BS 402 is aware that the PDCCH or PDSCH transmission in slot P is within the duration in time domain and location in frequency domain of the CO initiated by the UE 401. Since the BS 402 receives the PUSCH transmission using the UL reception Beam C, the BS 402 shall use the DL transmission Beam C, which corresponds to the UL reception Beam C, to perform the PDCCH or PDSCH transmission after performing the LBT Cat2.

In slot P, the BS 402 transmits the PDCCH/PDSCH transmission using the DL transmission beam C after performing the LBT Cat2, correspondingly, the UE 401 receives the PDCCH or PDSCH transmission using the DL reception beam B, which corresponds to the UL transmission Beam B.

It should be noted that the DL reception beam B used by UE 401 and the DL transmission beam C used by BS 402 correspond to each other, and the DL reception beam B used by UE 401 and the UL transmission beam B used by UE 401 also correspond to each other, that is, the DL reception beam B used by UE 401 has two corresponding beams, one is DL transmission beam C used by BS 402, and the other is the UL transmission beam B used by UE 401 per se.

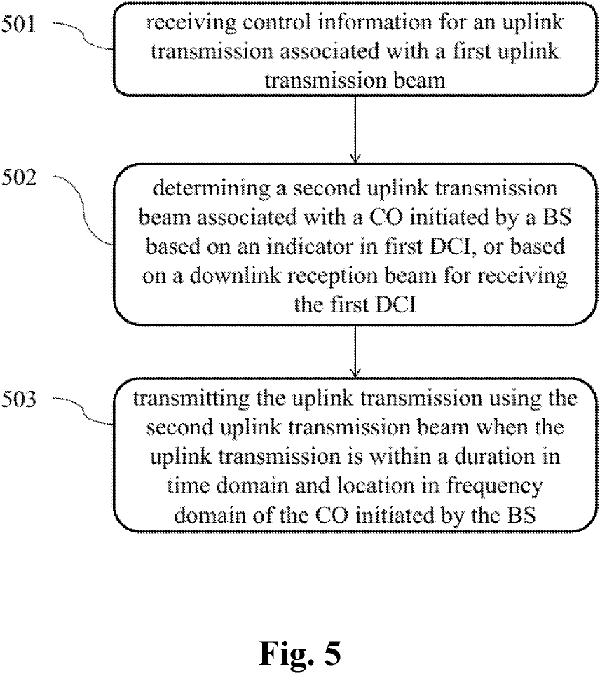

FIG. 5 illustrates a method performed by a UE for wireless communication according to a preferred embodiment of the present disclosure.

In step 501, the UE receives control information for an uplink transmission associated with a first uplink transmission beam, for example, the UE receives a singling from higher layer, and/or second DCI, which indicates a UL transmission Beam A for the PUCCH or PRACH transmission.

In step 502, the UE determines a second uplink transmission beam associated with a Channel Occupancy (CO) initiated by a base station (BS) based on an indicator in the first DCI. For example, the UE receives first DCI carrying an indicator indicating an uplink transmission beam B, then the UE determines the uplink transmission beam B based on the indicator in the first DCI for the PUCCH or PRACH transmission. Alternatively, in step 502, the UE determines a second uplink transmission beam associated with a Channel Occupancy (CO) initiated by a base station (BS) based on a downlink reception beam for receiving the first DCI. For instance, the UE may determine an uplink transmission Beam C based on DL reception beam C for receiving the first DCI.

In step 503, the UE transmits the uplink transmission using the second uplink transmission beam when the uplink transmission is within the duration in time domain and location in frequency domain of the CO initiated by the BS.

In one embodiment, the indicator indicates the second uplink transmission beam. In another embodiment, the indicator indicates a state indicating the second uplink transmission beam corresponding to an SRS resource. For example, in FIG. 3a, the indicator in the first DCI indicates the UL transmission beam B; or the indicator in the first DCI indicates a state corresponding to the UL transmission beam B. Furthermore, the indicator in the first DCI may indicate that the UE is not allowed to share the CO initiated by the BS.

Before transmitting the uplink transmission with the UL transmission beam B, the UE performs LBT Cat2.

In another embodiment, the second uplink transmission beam corresponds to the downlink reception beam. For example, in FIG. 3b, the uplink transmission beam C corresponds to the downlink reception beam C.

In yet another embodiment, the first uplink transmission beam and the second uplink transmission beam may be identical. That is, the uplink transmission beam B indicated in the first DCI may be identical to the uplink transmission beam A indicated by the second DCI and/or higher layer signaling.

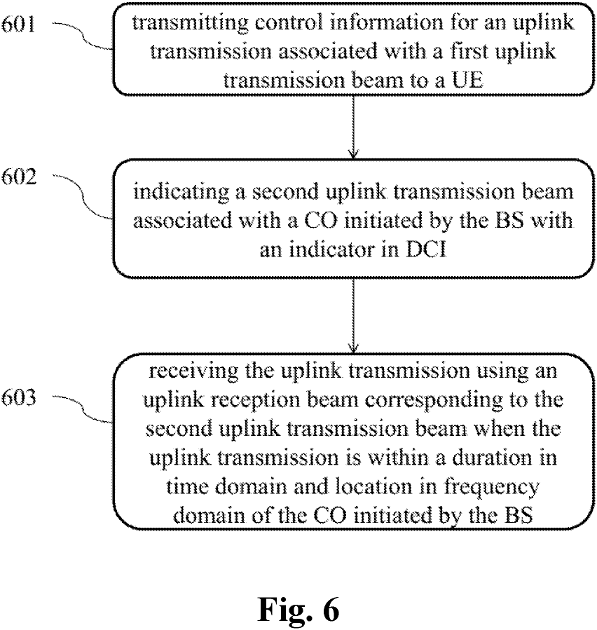

FIG. 6 illustrates a method performed by a BS for wireless communication according to a preferred embodiment of the present disclosure.

In step 601, the BS transmits control information for an uplink transmission, e.g. a PUCCH transmission, associated with a first uplink transmission beam to a UE.

In step 602, the BS indicates a second uplink transmission beam, which is UL transmission beam B in FIG. 3a, associated with a CO initiated by the BS with an indicator in DCI. In step 603, the BS receives the uplink transmission using an uplink reception beam, which corresponds to UL transmission beam B when the uplink transmission is within the duration in time domain and location in frequency domain of the CO initiated by the BS.

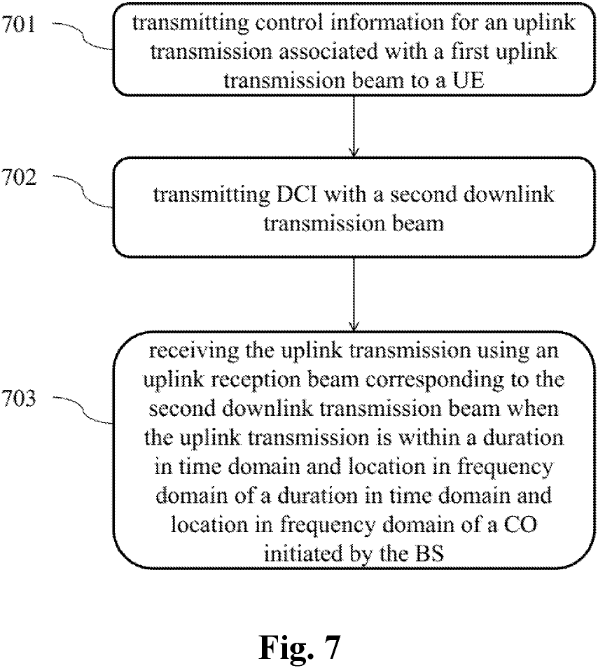

FIG. 7 illustrates another method performed by a BS for wireless communication according to a preferred embodiment of the present disclosure.

In step 701, the BS transmits control information for an uplink transmission, e.g. a PUCCH transmission, associated with a first uplink transmission beam to a UE.

In step 702, the BS transmits DCI with a second downlink transmission beam, which is DL transmission beam B in FIG. 3b; and in step 703, the BS receives the uplink transmission using an uplink reception beam, i.e. UL reception beam B, corresponding to DL transmission beam B when the uplink transmission is within the duration in time domain and location in frequency domain of the CO initiated by the BS.

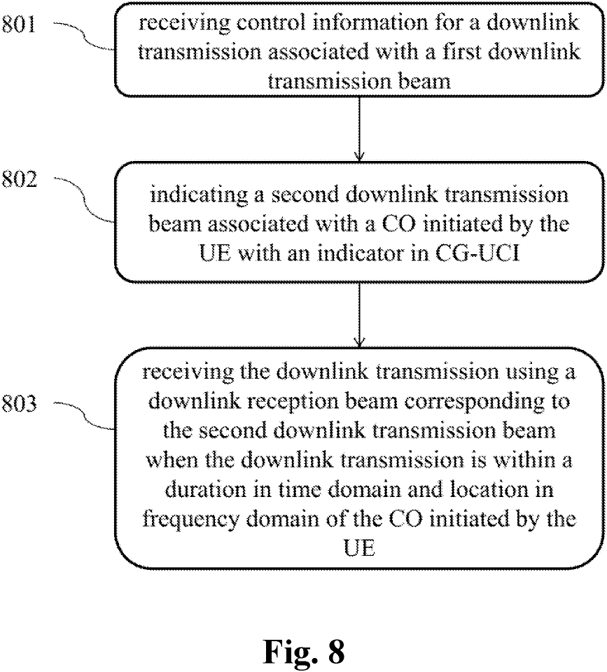

FIG. 8 illustrates another method performed by a UE for wireless communication according to a preferred embodiment of the present disclosure.

In step 801, the UE receives control information for a downlink transmission associated with a first downlink transmission beam, for instance, the UE receives the control information for the PDCCH or PDSCH transmission, which is associated with the downlink transmission beam A in FIG. 4a. The first downlink transmission beam may be indicated by DCI or by higher layer signaling.

In step 802, the UE indicates a second downlink transmission beam associated with a CO initiated by the UE with an indicator in CG-UCI. That is, the UE indicates the downlink transmission beam B associated with a CO initiated by the UE with an indicator in CG-UCI.

In step 803, the UE receives the downlink transmission using a downlink reception beam corresponding to the second downlink transmission beam when the downlink transmission is within the duration in time domain and location in frequency domain of the CO initiated by the UE. In FIG. 4a, the UE receives the PDCCH or PDSCH using the downlink reception beam corresponding to the downlink transmission beam B.

The indicator in CG-UCI may indicate the second downlink transmission beam, or may indicate that the BS is not allowed to share the CO initiated by the UE.

Alternatively, the indicator may include a state for indicating the second downlink transmission beam which corresponds to a Transmission Configuration Indicator (TCI) state, and the indicator may include a state for indicating that the BS is not allowed to share the CO initiated by the UE. In another embodiment, the indicator may include an index of a row of a table, wherein the row of the table at least indicates the second downlink transmission beam.

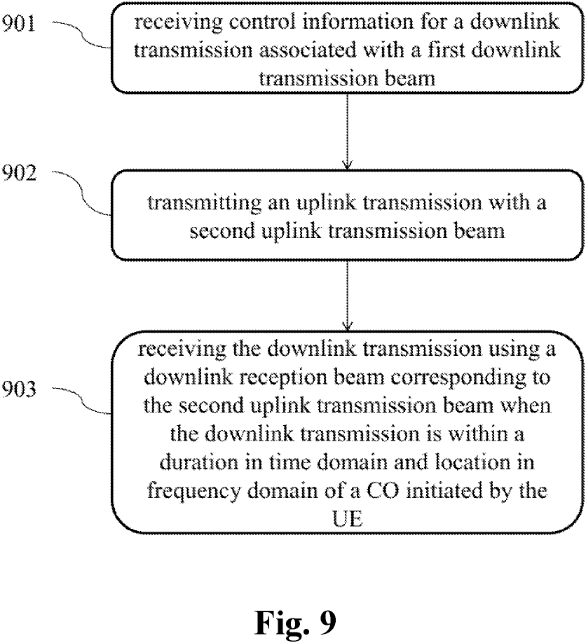

FIG. 9 illustrates another method performed by a UE for wireless communication according to a preferred embodiment of the present disclosure.

In step 901, the UE receives control information for a downlink transmission associated with a first downlink transmission beam, for instance, the UE receives the control information for the PDCCH or PDSCH transmission, which is associated with the downlink transmission beam A in FIG. 4b. The first downlink transmission beam may be indicated by DCI or by higher layer signaling.

In step 902, the UE transmits an uplink transmission, for example, a PUSCH transmission with a second uplink transmission beam, i.e. uplink transmission beam B in FIG. 4b.

In step 903, the UE receives the downlink transmission using a downlink reception beam corresponding to the second uplink transmission beam when the downlink transmission is within the duration in time domain and location in frequency domain of the CO initiated by the UE. In FIG. 4b, the UE receives the PDCCH or PDSCH using the downlink reception beam B corresponding to downlink transmission beam B.

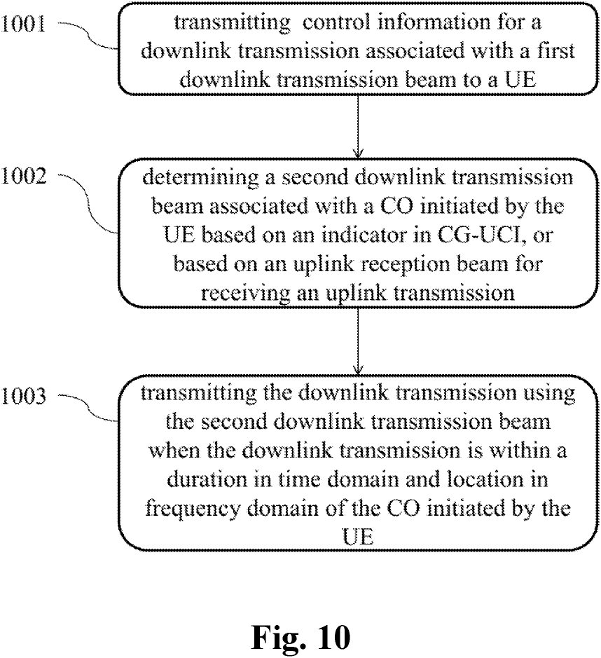

FIG. 10 illustrates another method performed by a BS for wireless communication according to a preferred embodiment of the present disclosure.

In step 1001, the BS transmits control information for a downlink transmission associated with a first downlink transmission beam to a UE, for example, the BS transmits DCI or higher layer signaling for PDCCH or PDSCH transmission associated with downlink transmission beam A to the UE.

In step 1002, the BS determines a second downlink transmission beam associated with a CO initiated by the UE based on an indicator in CG-UCI, or based on an uplink reception beam for receiving an uplink transmission. For instance, the UE indicates a downlink transmission beam B in the CG-UCI, thus the BS can use the downlink transmission beam B for PDCCH or PDSCH transmission in FIG. 4a. Or, the BS determines the downlink transmission beam C based on the uplink reception beam C for receiving the uplink transmission in FIG. 4b.

In step 1003, the BS transmits the downlink transmission using the second downlink transmission beam when the downlink transmission is within the duration in time domain and location in frequency domain of the CO initiated by the UE.

Before transmitting the downlink transmission using the second downlink uplink transmission beam, the BS performs a LBT Cat2.

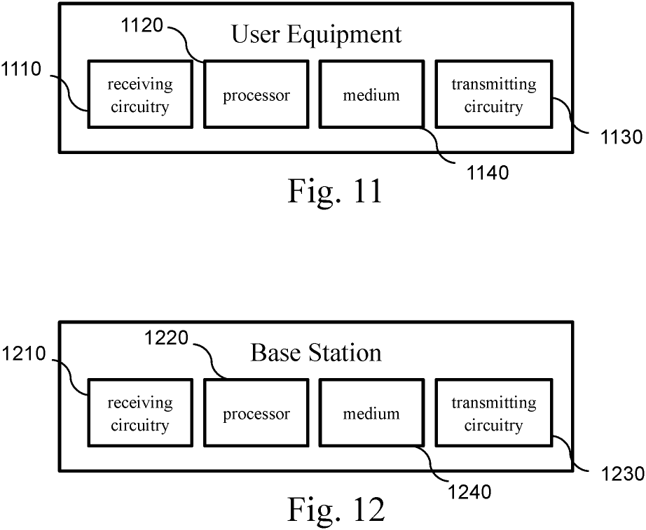

FIG. 11 illustrates a block a UE according to some embodiments of the present disclosure. The UE 101 may include a receiving circuitry, a processor, and a transmitting circuitry. In one embodiment, the UE 101 may include a non-transitory computer-readable medium having stored thereon computer-executable instructions; a receiving circuitry; a transmitting circuitry; and a processor coupled to the non-transitory computer-readable medium, the receiving circuitry and the transmitting circuitry. The computer executable instructions can be programmed to implement a method (e.g. the method in FIG. 5) with the receiving circuitry, the transmitting circuitry and the processor.

FIG. 12 illustrates a block illustrates a block a BS according to some embodiments of the present disclosure. The UE 102 may include a receiving circuitry, a processor, and a transmitting circuitry. In one embodiment, the UE 102 may include a non-transitory computer-readable medium having stored thereon computer-executable instructions; a receiving circuitry; a transmitting circuitry; and a processor coupled to the non-transitory computer-readable medium, the receiving circuitry and the transmitting circuitry. The computer executable instructions can be programmed to implement a method (e.g. the method in FIG. 6) with the receiving circuitry, the transmitting circuitry and the processor.

The method of the present disclosure can be implemented on a programmed processor. However, controllers, flowcharts, and modules may also be implemented on a general purpose or special purpose computer, a programmed microprocessor or microcontroller and peripheral integrated circuit elements, an integrated circuit, a hardware electronic or logic circuit such as a discrete element circuit, a programmable logic device, or the like. In general, any device that has a finite state machine capable of implementing the flowcharts shown in the figures may be used to implement the processing functions of the present disclosure.

While the present disclosure has been described with specific embodiments thereof, it is evident that many alternatives, modifications, and variations will be apparent to those skilled in the art. For example, various components of the embodiments may be interchanged, added, or substituted in other embodiments. Also, all of the elements shown in each figure are not necessary for operation of the disclosed embodiments. For example, one skilled in the art of the disclosed embodiments would be capable of making and using the teachings of the present disclosure by simply employing the elements of the independent claims. Accordingly, the embodiments of the present disclosure as set forth herein are intended to be illustrative, not limiting. Various changes may be made without departing from the spirit and scope of the present disclosure.

In this disclosure, relational terms such as “first,” “second,” and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “a,” “an,” or the like does not, without more constraints, preclude the existence of additional identical elements in the process, method, article, or apparatus that comprises the element. Also, the term “another” is defined as at least a second or more. The terms “including,” “having,” and the like, as used herein, are defined as “comprising.”

We claim:

1-21. (canceled)

22. User Equipment (UE), comprising:
a non-transitory computer-readable medium having stored thereon computer-executable instructions;
a receiving circuitry;
a transmitting circuitry; and
a processor coupled to the non-transitory computer-readable medium, the receiving circuitry and the transmitting circuitry,
wherein the computer-executable instructions cause the processor to implement a method, the method comprising:
receiving control information for an uplink transmission associated with a first uplink transmission beam;
determining a second uplink transmission beam associated with a Channel Occupancy (CO) initiated by a base station (BS) based on an indicator in first downlink control information (DCI), or based on a downlink reception beam for receiving the first DCI; and
transmitting the uplink transmission using the second uplink transmission beam when the uplink transmission is within a duration in time domain and location in frequency domain of the CO initiated by the BS.

23. The UE of claim 22, wherein the first uplink transmission beam is indicated by second DCI and/or higher layer signaling.

24. The UE of claim 22, wherein the indictor indicates the second uplink transmission beam.

25. The UE of claim 22, wherein the indictor includes a state indicating the second uplink transmission beam corresponding to a sounding reference signal (SRS) resource.

26. The UE of claim 22, further comprising:
performing a first category of channel access procedures before transmitting the uplink transmission using the second uplink transmission beam.

27. The UE of claim 22, wherein the second uplink transmission beam corresponds to the downlink reception beam.

28. The UE of claim 22, wherein the indictor includes a state indicating that the UE is not allowed to share the CO initiated by the BS.

29. The UE of claim 22, wherein the first uplink transmission beam and the second uplink transmission beam are identical.

30. A Base Station (BS), comprising:
a non-transitory computer-readable medium having stored thereon computer-executable instructions;
a receiving circuitry;
a transmitting circuitry; and
a processor coupled to the non-transitory computer-readable medium, the receiving circuitry and the transmitting circuitry,
wherein the computer-executable instructions cause the processor to implement a method, the method comprising:
transmitting control information for an uplink transmission associated with a first uplink transmission beam to a user equipment (UE);
transmitting downlink control information (DCI) with a second downlink transmission beam; and
receiving the uplink transmission using an uplink reception beam corresponding to the second downlink transmission beam when the uplink transmission is within a duration in time domain and location in frequency domain of a Channel Occupancy (CO) initiated by the BS.

31. User Equipment (UE), comprising:
a non-transitory computer-readable medium having stored thereon computer-executable instructions;
a receiving circuitry;
a transmitting circuitry; and
a processor coupled to the non-transitory computer-readable medium, the receiving circuitry and the transmitting circuitry,
wherein the computer-executable instructions cause the processor to implement a method, the method comprising:
receiving control information for a downlink transmission associated with a first downlink transmission beam;
indicating a second downlink transmission beam associated with a Channel Occupancy (CO) initiated by the UE with an indicator in configured grant uplink control information (CG-UCI); and
receiving the downlink transmission using a downlink reception beam corresponding to the second downlink transmission beam when the downlink transmission is within a duration in time domain and location in frequency domain of the CO initiated by the UE.

32. The UE of claim 31, wherein the first downlink transmission beam is indicated by downlink control information (DCI) or by higher layer signaling.

33. The UE of claim 31, wherein the indictor indicates the second downlink transmission beam.

34. The UE of claim 31, wherein the indicator indicates that the BS is not allowed to share the CO initiated by the UE.

35. The UE of claim 31, wherein the indicator includes a state for indicating the second downlink transmission beam which corresponds to a Transmission Configuration Indicator (TCI) state.

36. The UE of claim 31, wherein the indicator includes a state for indicating that the BS is not allowed to share the CO initiated by the UE.

37. The UE of claim 31, wherein the indicator includes an index of a row of a table, wherein the row of the table at least indicates the second downlink transmission beam.
